(19) United States
(12) Patent Application Publication
(10) Pub. No.: US 2007/0033874 A1
(43) Pub. Date: Feb. 15, 2007

(54) Concealed top track system for sliding doors

(75) Inventor: Kenneth Jacobs, Guildford (GB)

Correspondence Address: PEPE & HAZARD, LLP, 225 ASYLUM ST., HARTFORD, CT, 06103, US

(73) Assignee: Home Decor Holding Company

(21) Appl. No.: 11/203,255

(22) Filed: Aug. 12, 2005

(51) Int. Cl. E05D 15/20

(52) U.S. Cl. 49/130

(57) ABSTRACT

A concealing guide track assembly for the top of a pair of sliding doors of a wardrobe having top rails. An elongated top track for mounting on the top wall of the wardrobe has a base wall and spaced channels. First and second elongated guides have a tubular formation along one side edge thereof slidably seated in one of the U-shaped portions of the top track and the other side edge engaged with one of the top rails so as to be slidable therewith. The guides have a bridge portion extending between the side edges, and the second guide bridge portion extends over the bridge portion of the first guide.

### BACKGROUND OF THE INVENTION

The present invention relates to sliding doors and more particularly to a door mounting track system which can be mounted at the front of a free standing wardrobe.

Sliding doors are widely employed in closet installations and in free standing wardrobes. In some installations, the weight of the doors is carried by rollers seated in an upper track; in other installations, the weight of the doors is carried by rollers that slide in a floor mounted track.

For a free standing wardrobe in which the doors will be mounted at the front of the wardrobe, it is desirable to employ track components which do not adversely affect the overall appearance of the installation. Moreover, the support system should exhibit long life. Generally, such installations for free standing wardrobes have load bearing wheels or rollers on the sliding doors which run in a track positioned on the floor immediately in front of the wardrobe. The top of each of the doors is typically retained in and guided by means of a track section attached to the top of the wardrobe. Many such installations require a multiplicity of compounds and fasteners and can require a substantial amount of time for installation.

Moreover, many such installations do not present an aesthetically pleasing appearance since elements of hardware are exposed to a view from within the room.

It is an object of the present invention to provide a novel top track assembly for sliding doors which can be fabricated easily and economically.

It is also an object to provide such a track assembly which the components may be quickly installed at the front of a free standing wardrobe.

Another object is to provide such a track assembly which will exhibit long life.

### SUMMARY OF THE INVENTION

It has now been found that the foregoing and related objects may be readily attained in a concealing guide track assembly for the top of a pair of sliding doors of a wardrobe comprising a pair of doors having top rails. An elongated top track for mounting on the top wall of the wardrobe has a base wall and spaced parallel U-shaped forward and rearward channels.

First and second elongated guides each have a generally tubular formation along one side edge thereof slidably seated in one of the U-shaped portions of the top track and have the other side edge engaged with one of the top rails so as to be slidable therewith. The guides also have a bridge portion extending between the side edges, the first guide having the first generally tubular formation seated in the forward channel of the top track and the other side edge engaged with the top rail on the rearward door, the second guide having a generally cylindrical formation seated in the rearward channel of the top track and its other side edge engaged with the guide track rail of the forward door, the second guide bridge portion extending over the bridge portion of the first guide.

Preferably, the top rails have a pair of spaced, upwardly opening channels and an intermediate inverted U-shaped portion providing a downwardly open channel receiving the door panel, and the guides have a generally cylindrical formation on the other side edge thereof.

Rail stops or bungs are seated in the ends of the top rails and having an upwardly opening channels therein which seat the other side edges of the guides. The guides have generally cylindrical formations along the other side edges, and the rail stops and cylindrical formations are cooperatively dimensioned and configured so that the cylindrical formations snap into the channels.

The top track has forward and rearward walls connected between the sides of the base wall and the portions providing the channel, and side passages are provided between the forward and rearward walls and the channel providing portions. End caps are seated in the ends of the top track. The U-shaped channel portions are spaced apart to provide a center passage therebetween. The caps have an end wall and projecting portions which seat in the side passages and in the center passage. The projecting portion in the center passage has an aperture therein to receive a fastener which will seat in the top wall of the wardrobe.

Synthetic resin bearing members are seated in the tubular formations to provide a low friction surface and bearing members have a body portion seated in the tubular formation and a collar disposed outwardly thereof which is of larger diameter. The collar is also of larger diameter than the channels of the top track so as to snap fit thereinto.

### BRIEF DESCRIPTION OF THE DRAWINGS

FIG. 1 is a perspective view of a wardrobe upon which has been installed a top guide track assembly embodying the present invention;

FIG. 2a is a sectional view along the line 2-2 of FIG. 1;

FIG. 2b is a fragmentary perspective view of the top track assembly;

FIG. 3 is a perspective view of the top rail;

FIG. 4 is a cross sectional view of the top rail;

FIG. 5 is a perspective view of the top track;

FIG. 6 is a cross sectional view of the top track;

FIG. 7 is a perspective view of the end cap;

FIG. 8 is a cross sectional view of the end cap;

FIG. 9 is a bottom perspective view of the top rail bung;

FIG. 10 is a top perspective view of the top rail bung;

FIG. 11 is a perspective view of the short arm guide;

FIG. 12 is a cross sectional view of the short arm guide;

FIG. 13 is a perspective view of the long arm guide;

FIG. 14 is a cross sectional view of the long arm guide;

FIG. 15 is a perspective view of the track bearing;

FIG. 16 is a fragmentary sectional view showing the track bearing seated in the tubular formation of the guide and the track; and

FIG. 17 is a front view of the wardrobe with the top track assembly assembled thereon.

### DETAILED DESCRIPTION OF THE PREFERRED EMBODIMENT

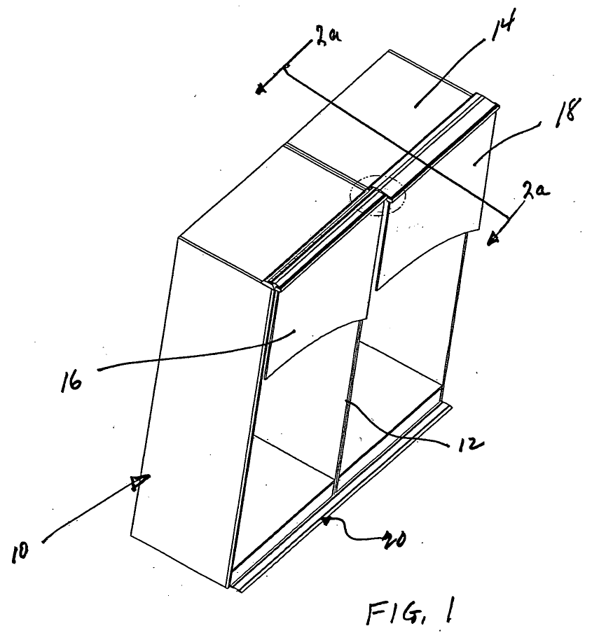

Turning first to FIG. 1, therein illustrated is a wardrobe with the concealing top track assembly of the present invention. The wardrobe is generally designated by the numeral 10 and has an interior space with a divider 12, and a top wall 14. A pair of sliding doors generally designated by the numerals 16, 18, are dimensioned to close the open face of the wardrobe 10 and are supported for movement on a bottom track assembly generally designated by the numeral 20.

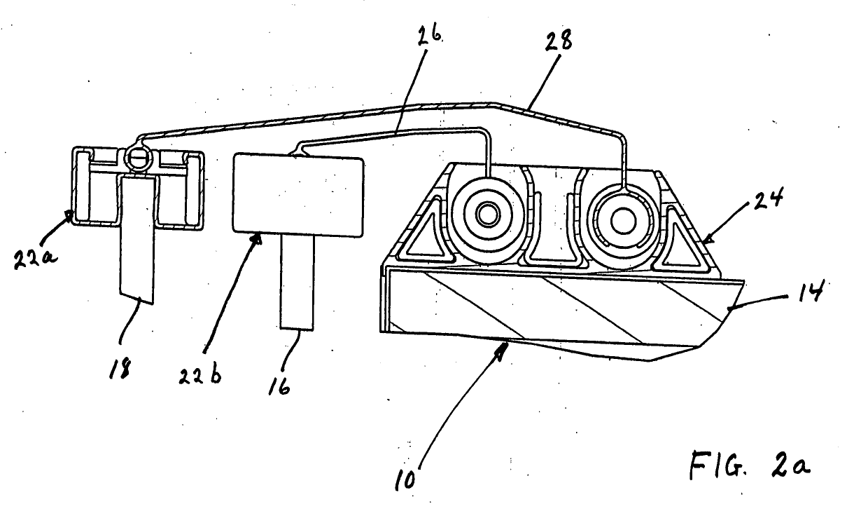

As seen in FIGS. 2a and 2b, the top track assembly of the present invention includes the top rails generally designated by the numerals 22a and 22b of the doors 16, 18, the top track generally designated by the numeral 24 which is mounted on the top wall 14 of the wardrobe 10 and inner and outer guides generally designated by the numerals 26, 28. The guides 26, 28 are coupled to the top rails 22a and 22b on the doors 16, 18 so that they move as a unit with the associated door and they conceal most of the top track components as they are guided in their movement relative to the wardrobe 10 and the top track 24.

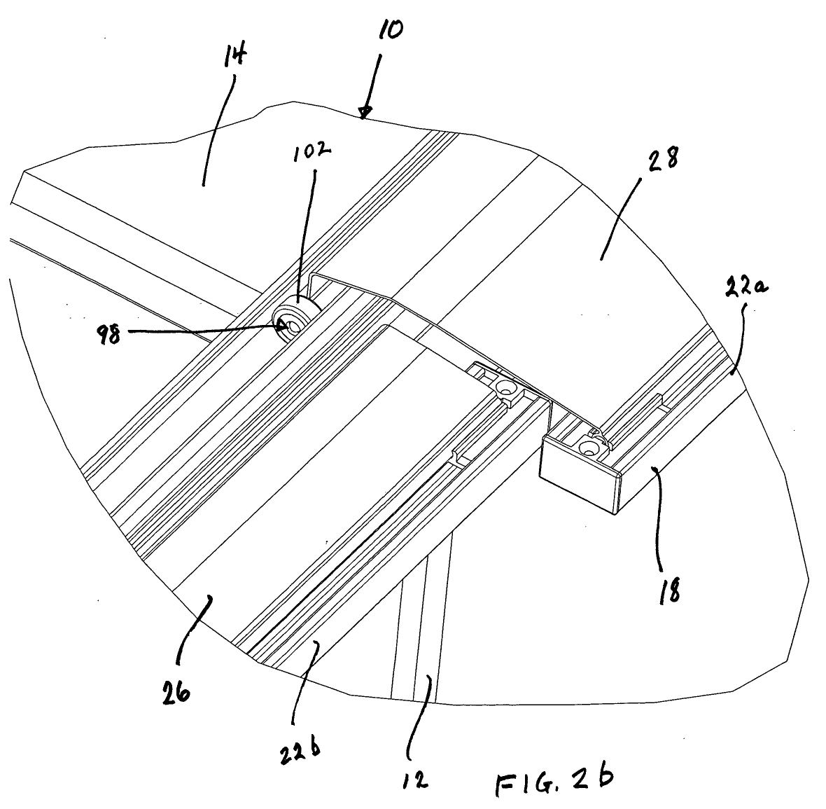

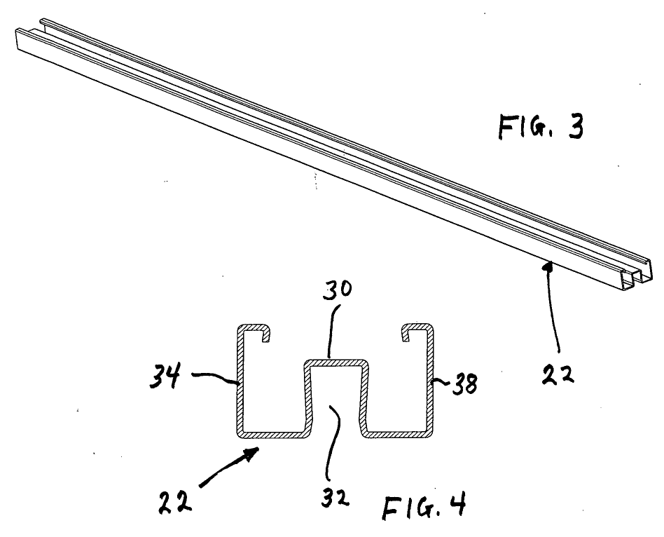

Turning first in detail to the top rails 22 of the doors, these are illustrated in FIGS. 3 and 4 and they may be extruded or roll formed with a generally W-shaped cross section. At the center of the cross section is an inverted U-shaped portion 30 providing a downwardly opening channel 32 in which the upper edge of the panel 16, 18 is seated. To one side of the U-shaped portion 30 is a generally L-shaped portion 34 and the other side is a reverse L-shaped portion providing an upwardly opening channel 38 therebetween.

Inserted into the ends of the top rails 22 are synthetic resin rail bungs generally designated by the numeral 40 and which are illustrated in FIGS. 9 and 10. These bungs 40 are molded with an end wall 42, side walls 44, and a top wall 46 which has a slot 48 bounded by arcuate bosses 58 which define a recess or channel 60 therebetween.

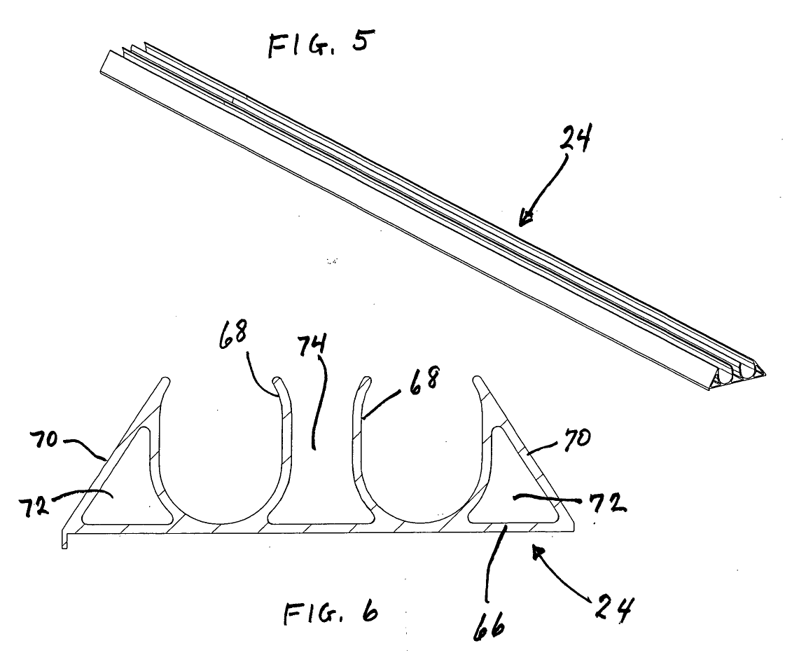

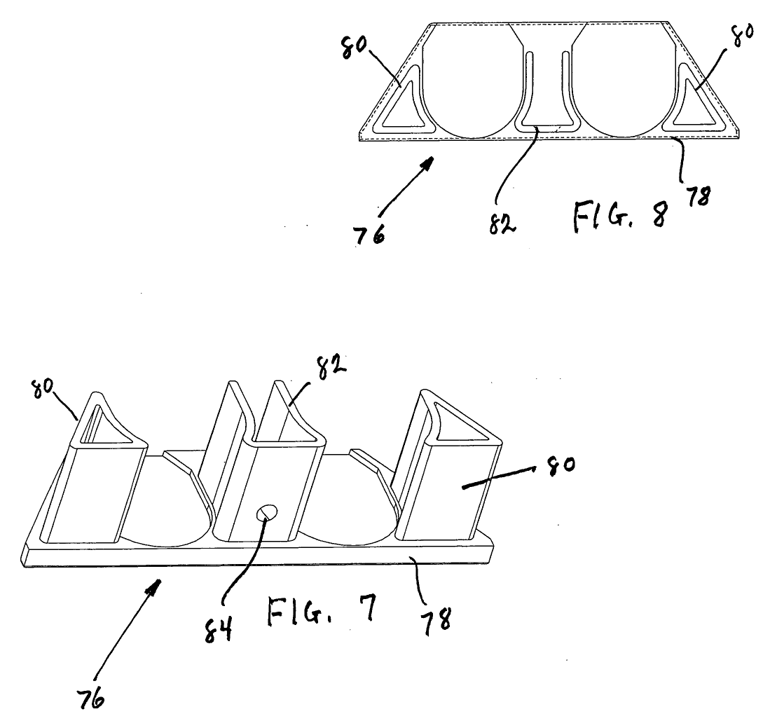

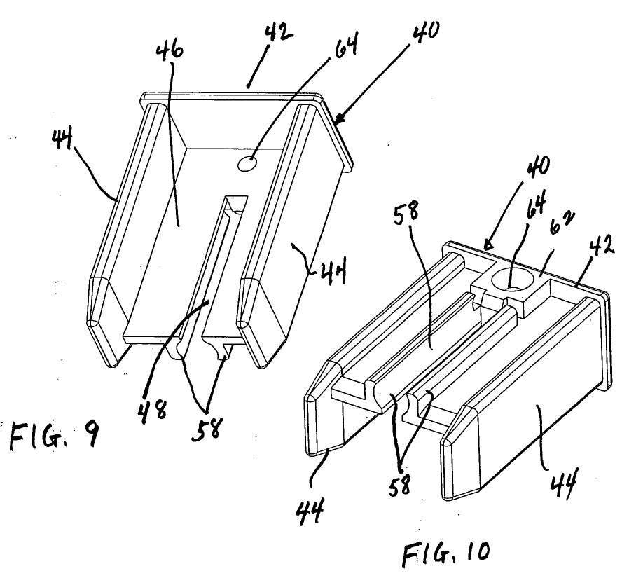

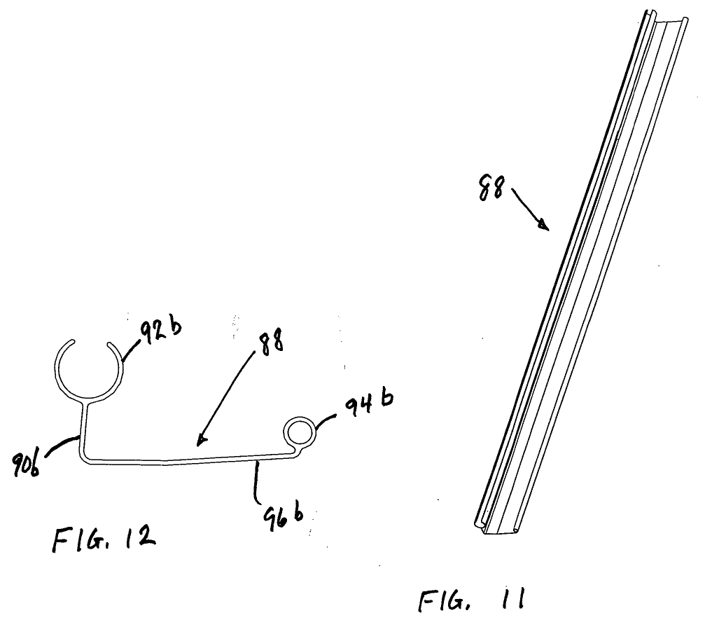

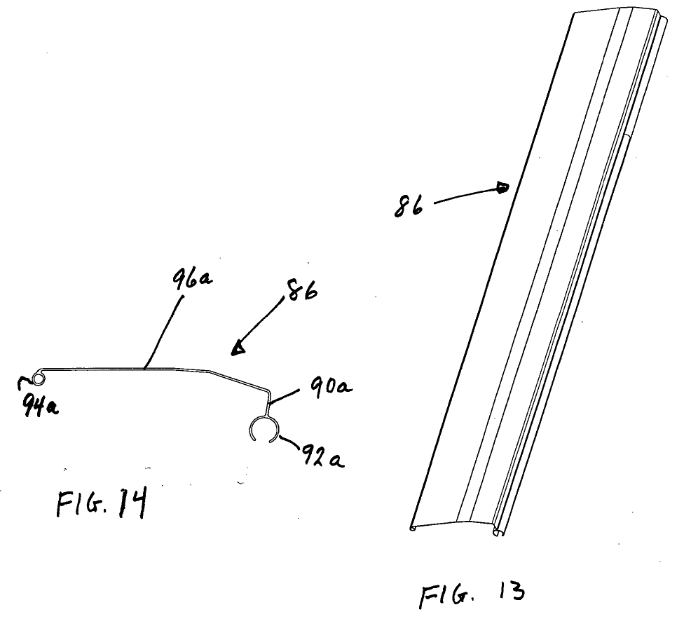

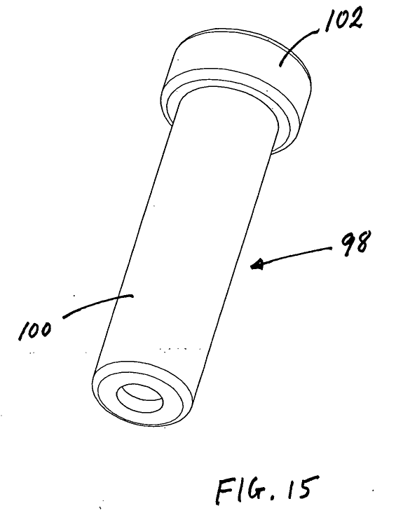

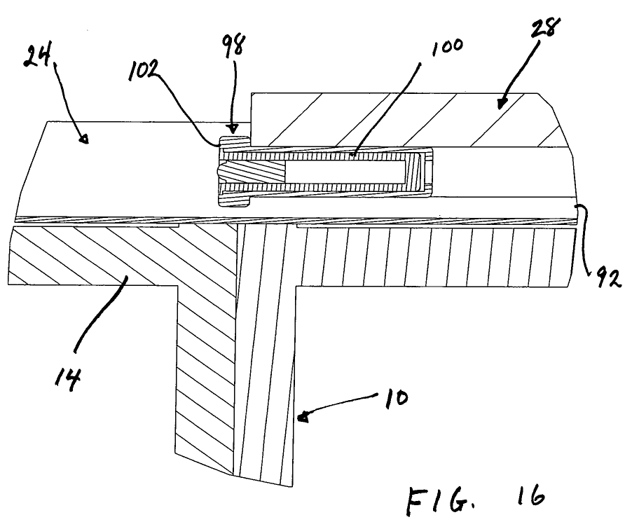

Turning next to FIGS. 5 and 6, the top track 24 is a synthetic resin extrusion which has a base wall 66, a pair of generally U-shaped channel portions 68, angled side walls 70 which extend between the sides of the base wall 66, and the channel portions 68 adjacent the upper ends to provide passages 72 therebetween. The U-shaped channel portions 68 are spaced apart to provide a passage 74 therebetween.

Seated in the ends of the top track 24 is a synthetic resin stop illustrated in FIGS. 7 and 8 and generally designated by the numeral 76. The stop 76 has an end wall 78, a pair of tubular projections 80 which extend into the passages 72 of the top track 24 and a central projection 82 which extends into the central passage 74. An aperture 84 is provided in the central projection 82 for seating a fastener (not shown) to mount the top track 24 on the top wall 14 of the wardrobe 10.

Turning next to FIGS. 11-14, the elongated guides generally designated by the numerals 86, 88 are conveniently extruded or roll formed and have a side wall 90a, 90b, with a generally tubular formation 92a, 92b at the base thereof, and a generally cylindrical portions 94a, 94b which are of smaller diameter than the formations 92a, 92b along the other side edge thereof. Extending transversely between the formations 92a, 92b, 94a, 94b are bridge portions 96a, 96b. The bridge portion 96a is of greater width than the bridge portion 96b and it is comprised of several segments whereas the bridge portion 96b is essentially rectilinear.

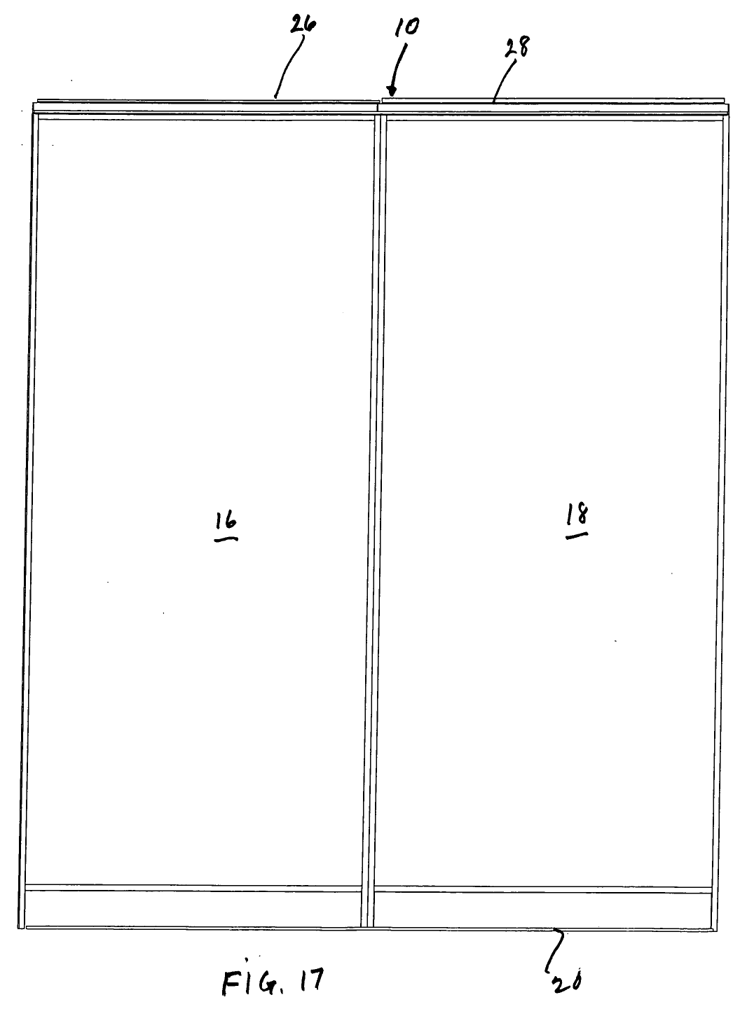

Turning next to FIGS. 15 and 16, seated in the ends of the tubular formations 92a, 92b are synthetic resin bearing members generally designated by the numeral 98 and which have a body portion 100 snugly seated in the tubular formation 92a, 92b and a collar portion 102 having an outer diameter larger than the outer diameter of the tubular formations 92a, 92b. The collar portion 102 is also of larger diameter than the opening into the channel portion 68 so that it will snap thereinto and be retained therein.

In assembling the doors to a wardrobe, the bottom track 20 is installed on the floor adjacent the front of the wardrobe and the rollers (not shown) are installed in the bottom of the doors which are seated in the bottom track 20. The bungs 40 are seated in the top rails 22.

The caps or stops 76 are inserted into the ends of the top track 24 and the top track 24 is secured to the top wall 14 of the wardrobe 10 by fasteners (not shown) which are inserted into the apertures 84. The bearings 98 are inserted into the ends of the short guide 26, and its tubular formation 92 and bearings 98 are pressed into the forward channel 68 and the guide 86 is then pivoted to snap the cylindrical formation 94 into the channel provided between the arcuate bosses 58 of the bungs 40.

The long guide 28 is similarly mounted in the rearward channel 68 of the top track 24 and pivoted to snap into the channel provided by the arcuate bosses 58 of the bungs in the top rail of the forward door. As a result, the upper end of the doors 16, 18 are guided along the top track 24 and the generally vertical forward faces of the guides 26, 28 conceal the other posts of the top track assembly structure to provide a pleasing appearance.

The components of the track assembly can be readily fabricated and at relatively low cost. The guides can be extruded or roll formed from metal to provide the desired contours including the tubular formation along one edge and the cylindrical formation along the other edge.

The top track is conveniently extruded from synthetic resin having reasonable flexibility to permit the “snap into” feature.

The bungs for the top rails of the door are conveniently molded from a low friction synthetic resin such as nylon or polypropylene. The end caps for the top track are conveniently molded from synthetic resin.

As indicated above, the rack assembly of the present invention requires only two fasteners for the ends of the top track and several fasteners for the bottom track. The guide rails are snapped into the top track and top rail of the doors.

Since the long guide extends over the shorter guide, there is no interference in the movement of the doors, and adjustments can be readily made in the supporting rollers or wheels of the bottom track assembly. Any change in vertical height is easily accommodated by pivoting of the guides.

Thus, it can be seen from the foregoing detailed specification and attached drawings that the top track assembly of the present invention is one which is relatively simple and economical to fabricate, and it can be readily and quickly installed. The weight of the door is carried by the bottom track assembly which is desirably fabricated from components exhibiting long life so as to provide an overall long lived assembly with relatively little wear taking place in the top track assembly which has little load upon it.

Having thus described the invention, what is claimed is:

1. A concealing guide track assembly for the top of a pair of sliding doors of a wardrobe comprising:
(a) a pair of doors having top rails;
(b) an elongated top track for mounting on the top wall of the wardrobe and having a base wall and spaced parallel U-shaped forward and outer rearward channels; and
(c) first and second elongated guides each having a generally tubular formation along one side edge thereof slidably seated in one of said U-shaped portions of said top track and having the other side edge engaged with one of said top rails so as to be slidable therewith, said guides also having a bridge portion extending between said side edges, said first guide having said generally tubular formation seated in the forward channel of said top track and the other side edge engaged with the guide rail on the rearward door, said second guide having a generally cylindrical formation seated in the rearward channel of said top track and its other side edge engaged with said top rail of the forward door, said second guide bridge portion extending over the bridge portion of said first guide.

2. The concealing guide track assembly in accordance with claim 1 wherein said door top rails have a pair of spaced, upwardly opening channels and an intermediate inverted U-shaped portion, providing said downwardly open channel.

3. The concealing guide track assembly in accordance with claim 1 wherein said guides have a generally cylindrical formation on said other side edge thereof.

4. The concealing guide track assembly in accordance with claim 1 wherein there are included bungs seated in the ends of said top rails, said bungs having an upwardly opening channel therein which seats said other side edge of said guides.

5. The concealing guide track assembly in accordance with claim 4 wherein said guides have generally cylindrical formations along said other side edges and wherein said rail bungs and cylindrical formations are cooperatively dimensioned and configured so that said cylindrical formations snap into said channels.

6. The concealing guide track assembly in accordance with claim 1 wherein said top track has forward and rearward walls connected between said the sides of said base wall and the portions providing said channels.

7. The concealing guide track assembly in accordance with claim 6 wherein there are side passages between said forward and rearward walls and said channel providing portions.

8. The concealing guide track assembly in accordance with claim 7 wherein there are included end caps seated in the ends of said top track.

9. The concealing guide track assembly in accordance with claim 8 wherein said U-shaped channel portions are spaced apart to provide a center passage therebetween.

10. The concealing guide track assembly in accordance with claim 9 wherein said end caps have an end wall and projecting portions which seat in said side passages and in said center passage.

11. The concealing guide track assembly in accordance with claim 10 wherein said projecting portion in said center passage has an aperture therein to receive a fastener which will seat in the top wall of the wardrobe.

12. The concealing guide track assembly in accordance with claim 1 wherein synthetic resin bearing members are seated in said tubular formations to provide a low friction surface.

13. The concealing guide track assembly in accordance with claim 12 wherein said bearing members have a body portion seated in the cylindrical formation and a collar disposed outwardly thereof which is of larger diameter the said tubular formation.

14. The concealing guide track assembly in accordance with claim 13 wherein said collar is of larger diameter than the opening into said channels of said top track so as to snap fit thereinto.

15. A concealing guide track assembly for the top of a pair of sliding doors of a wardrobe comprising:
(a) a pair of doors having top rails providing upwardly open channels;
(b) rail bungs seated in the ends of said top rails, said bungs having an upwardly opening channel therein which seats said other side edge of said guides;
(c) an elongated top track for mounting on the top wall of the wardrobe and having a base wall and spaced parallel U-shaped inner and outer channels; and
(d) first and second elongated guides each having a generally tubular formation along one side edge thereof slidably seated in one of said U-shaped portions of said top track and having a generally cylindrical formation on said other side edge thereof, the other side edge engaged with one of said top rails so as to be slidable therewith, said rail bungs and cylindrical formations are cooperatively dimensioned and configured so that said cylindrical formations snap into said channels, said guides also having a bridge portion extending between said side edges, said first guide having said generally tubular formation seated in the forward channel of said top track and the other side edge engaged with the top rail on the rearward door, said second guide having a generally cylindrical formation seated in the rearward channel of said top track and its other side edge engaged with said top rail of the forward door, said second guide bridge portion extending over the bridge portion of said first guide.

16. The concealing guide track assembly in accordance with claim 15 wherein there are included bearing members having0 a body portion seated in the cylindrical formation and a collar disposed outwardly thereof which is of larger diameter that said tubular formation and the width of the opening into said channels of said top track so as to snap fit thereinto.

17. A concealing guide track assembly for the top of a pair of sliding doors of a wardrobe comprising:
(a) a pair of doors;
(b) an elongated top track for mounting on the top wall of the wardrobe and having a base wall and spaced parallel U-shaped inner and outer channels to provide a center passage therebetween; and
(c) first and second elongated guides each having a generally tubular formation along one side edge thereof slidably seated in one of said U-shaped portions of said top track and having the other side edge engaged with one of said guide rails so as to be slidable therewith, said guides also having a bridge portion extending between said side edges, said first guide having said generally tubular formation seated in the forward channel of said top track and the other side edge engaged with the top rail on the rearward door, said second guide having a generally cylindrical formation seated in the rearward channel of said top track and its other side edge engaged with said top rail of the forward door, said second guide bridge portion extending over the bridge portion of said first guide, and end caps seated in the ends of said top track, an end wall and projecting portions which seat in said side passages and in said center passage, said projecting portion in said center passage has an aperture therein to receive a fastener which will seat in the top wall of the wardrobe.

18. The concealing guide track assembly in accordance with claim 17 wherein said bearing members have a body portion seated in the cylindrical formation and a collar disposed outwardly thereof which is of larger diameter than said formation, said collar being of larger diameter than the opening into said channels of said top track so as to snap fit thereinto.
